(19) United States
(12) Patent Application Publication
(10) Pub. No.: US 2018/0356756 A1
(43) Pub. Date: Dec. 13, 2018

(54) FIXING DEVICE

(71) Applicants: KABUSHIKI KAISHA TOSHIBA, Tokyo (JP); TOSHIBA TEC KABUSHIKI KAISHA, Tokyo (JP)

(72) Inventors: Taishi Takano, Shimizu Sunto (JP); Maiko Miyoshi, Izunokuni (JP); Li Xu, Mishima (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/836,502

(22) Filed: Dec. 8, 2017

(30) Foreign Application Priority Data
Jun. 9, 2017 (JP) 2017-114655

(51) Int. Cl. G03G 15/20; G03G 9/09

(52) U.S. Cl. CPC G03G 15/2085; G03G 9/09; G03G 15/2075; G03G 15/2078

(57) ABSTRACT

A fixing device includes a fixing member, a pressing member, and a slide-contacting member. The fixing member heats a sheet, on which a toner image is formed, while rotating. The pressing member comes into press-contact with the fixing member to form a nip section. The pressing member nips and transports the sheet while rotating along with the fixing member. The slide-contacting member is disposed to be in contact with the fixing member and performs slide-contact cleaning by urging a slide-contacting surface with respect to a surface of the rotating fixing member when a sheet on which a toner image containing a photoluminescent pigment is formed passes through the nip section.

### CROSS-REFERENCE TO RELATED APPLICATION

This application is based upon and claims the benefit of priority from Japanese Patent Application No. 2017-114655, filed Jun. 9, 2017, the entire contents of which are incorporated herein by reference.

### FIELD

Embodiments described herein relate to a fixing device.

### BACKGROUND

In the related art, an electrophotographic image forming apparatus is known. The electrophotographic image forming apparatus transfers a toner image onto a paper sheet, which is a recording medium, based on image information and fixes an image by heating and pressing the paper sheet onto which the toner image is transferred. The image forming apparatus is provided with a fixing device that performs a fixing process.

In recent years, the number of users who want to add a high value to images is increasing. Application of photoluminescence properties that exhibit a luster such as a metallic luster or a pearly luster is one method for adding a high value to images. Examples of coloring materials that apply photoluminescence properties to an image include a photoluminescent pigment such as an aluminum pigment and a pearl pigment. Since the larger the light reflecting surface, the higher amount of luster is exhibited, every photoluminescent pigment has a large particle diameter and the photoluminescent pigment has a scale-like shape in many cases. Therefore, if image formation is performed by using toner in which a photoluminescent pigment is included in a particle, a surface of the fixing device may be damaged when heat and pressure are applied in the fixing process. If the image formation is continued while using the fixing device with the damaged surface, there is a possibility of image roughness and toner offset.

### DESCRIPTION OF THE DRAWINGS

FIG. 1 is a vertical sectional view schematically illustrating a configuration of an image forming apparatus including a fixing device according to a first embodiment.

FIG. 2 is a side view schematically illustrating a configuration of a fixing device.

FIG. 3 is a perspective view schematically illustrating a configuration of a slide-contacting member of a fixing device.

FIG. 4 is a flowchart illustrating an example of the operation of a fixing device.

FIGS. 5A to 5D illustrate an example of a job processed by a fixing device.

FIG. 6 is a side view schematically illustrating a configuration of a fixing device according to a second embodiment.

FIG. 7 is a side view schematically illustrating a configuration of a fixing device according to a third embodiment.

FIG. 8 is a table showing examples of results of measurement on the effect of slide-contact cleaning according to Examples 1 to 4.

FIGS. 9A and 9B show images of results of measurements on the effect of slide-contact cleaning according to Example 5.

FIGS. 10A and 10B show images of results of measurements on the effect of slide-contact cleaning according to Example 6.

### DETAILED DESCRIPTION

The present disclosure describes embodiments of a fixing device that is able to stably repeat an image fixing process by recovering the state of a surface of a fixing member that performs a process of fixing an image containing a photoluminescent pigment.

According to one embodiment, a fixing device includes a fixing member, a pressing member, and a slide-contacting member. The fixing member heats a sheet, on which a toner image is formed, while rotating. The pressing member comes into press-contact with the fixing member to form a nip section. The pressing member nips and transports the sheet while rotating along with the fixing member. The slide-contacting member is disposed to be in contact with the fixing member and performs slide-contact cleaning by urging a slide-contacting surface with respect to a surface of the rotating fixing member when a sheet on which a toner image containing a photoluminescent pigment is formed passes through the nip section.

Hereinafter, a fixing device according to embodiments will be described in detail with reference to accompanying drawings. In each drawing, the same component is given the same reference numeral.

### First Embodiment

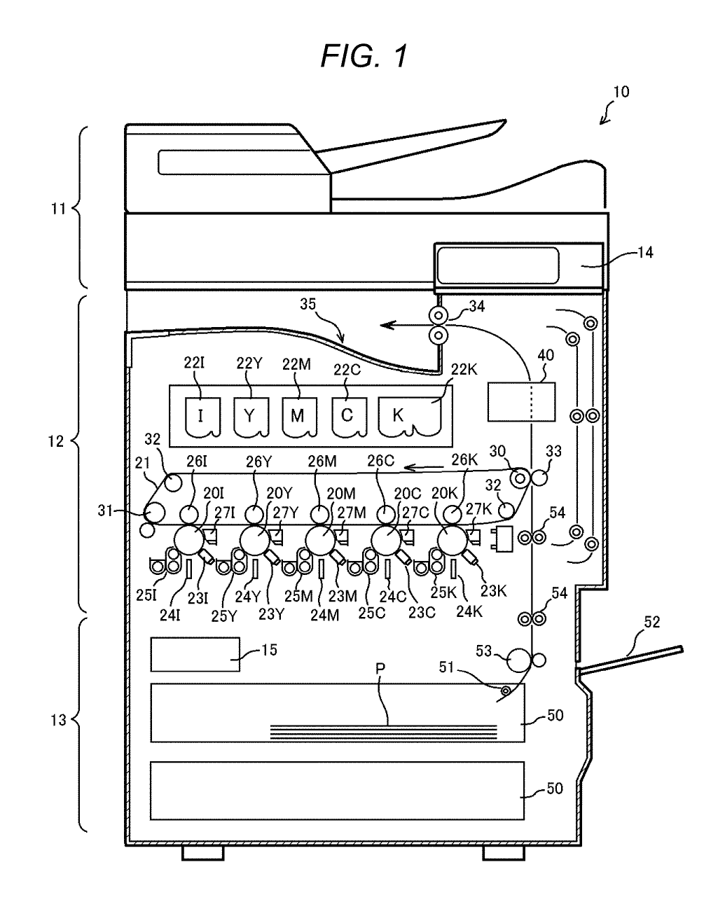

FIG. 1 is a vertical sectional view schematically illustrating a configuration of a multi-function peripheral (MFP) which is an example of an image forming apparatus 10 provided with a fixing device according to a first embodiment. As illustrated in FIG. 1, the image forming apparatus 10 includes an image reading unit 11, an image forming unit 12, a paper feeding unit 13, an operation unit 14, an operation controller 15, and the like.

The image reading unit 11 includes an optical scanner that optically reads an image on an original document. The image reading unit 11 optically reads an image on an original document manually placed at an original document reading position or an image on an original document that is supplied to the original document reading position by an auto document feeder (ADF), generates image data, and outputs the image data.

The image forming unit 12 forms a toner image on a surface of a sheet P, which is a recording medium such as a recording sheet or a film, based on the image data generated by the image reading unit 11 or image data transmitted from an external device that is connected to the image forming unit 12 via an interface. The image forming unit 12 forms the toner image using a tandem system. A toner image containing a photoluminescent pigment is also formed using the tandem system.

In the image forming unit 12, photoconductive drums (20Y, 20M, 20C, 20K, and 20I) that respectively correspond to colors of yellow (Y), magenta (M), cyan (C), and black (K) and photoluminescence properties (I) are arranged in a rotation direction of a transfer belt 21. Furthermore, in the image forming unit 12, toner cartridges (22Y, 22M, 22C, 22K, and 22I) supplying toners for respective colors are arranged.

On an outer circumferential surface of each of the photoconductive drums (20Y, 20M, 20C, 20K, and 20I), a charging device (23Y, 23M, 23C, 23K, and 23I), an exposure device (24Y, 24M, 24C, 24K, and 24I), a development device (25Y, 25M, 25C, 25K, and 25I), a primary transfer roller (26Y, 26M, 26C, 26K, and 26I), a cleaner (27Y, 27M, 27C, 27K, and 27I), and the like are arranged in accordance with the sequence in a primary transfer process. Each charging device (23Y, 23M, 23C, 23K, and 23I) charges a surface of each photoconductive drum (20Y, 20M, 20C, 20K, and 20I) to a predetermined potential. Each exposure device (24Y, 23M, 24C, 24K, and 24I) irradiates a surface of each of the photoconductive drums (20Y, 20M, 20C, 20K, and 20I) corresponding to the respective colors with laser light subject to pulse width modulation based on the level of image data related to the respective colors of yellow, magenta, cyan, and black and photoluminescence properties. When the potential of a portion irradiated with the laser light is decreased, an electrostatic latent image corresponding to image data of each color is formed on the surface of each of the photoconductive drums (20Y, 20M, 20C, 20K, and 20I).

Each development device (25Y, 25M, 25C, 25K, and 25I) is provided with a development roller and a mixer. Each development device (25Y, 25M, 25C, 25K, and 25I) stirs and mixes a two-component developer, which is a mixture of toner and a carrier, and supplies toner to a surface of each photoconductive drum (20Y, 20M, 20C, 20K, and 20I) by using the development roller. The electrostatic latent image formed on the surface of each photoconductive drum (20Y, 20M, 20C, 20K, and 20I) are developed by toner of each color.

Each primary transfer roller (26Y, 26M, 26C, 26K, and 26I) is disposed to face each photoconductive drum (20Y, 20M, 20C, 20K, and 20I) with the transfer belt 21 interposed therebetween. The toner images respectively formed on the surfaces of the photoconductive drums (20Y, 20M, 20C, 20K, and 20I) are subsequently transferred (primary transfer) onto a surface of the transfer belt 21 when the transfer belt 21 rotates and passes through an area between the photoconductive drums (20Y, 20M, 20C, 20K, and 20I) and the primary transfer rollers (26Y, 26M, 26C, 26K, and 26I) and a toner image corresponding to image data is formed on the surface of the transfer belt 21. If there is toner remaining on the surfaces of the photoconductive drums (20Y, 20M, 20C, 20K, and 20I) after the primary transfer, the cleaners (27Y, 27M, 27C, 27K, and 27I) recover the toner.

The endless transfer belt 21 is supported by a driving roller 30, a driven roller 31, and a tension roller 32. When the driving roller 30 rotates, the transfer belt 21 continuously rotates in a direction illustrated by an arrow. Furthermore, a secondary transfer roller 33 is disposed to face the driving roller 30 with the transfer belt 21 interposed therebetween. The toner image primarily transferred to the surface of the transfer belt 21 is transferred (secondary transfer) to a surface of the sheet P, which is a recording medium, when the transfer belt 21 rotates and passes through an area between the driving roller 30 and the secondary transfer roller 33.

The image forming unit 12 is further provided with a fixing device 40. The fixing device 40 performs a fixing process, which will be described later in detail, to fix a toner image on a surface of the sheet P via application of heat and pressure. The sheet P with an image that is formed on the surface thereof in the fixing process is transported along a transportation path by a plurality of pairs of transportation rollers 34 and is discharged onto a discharge tray 35.

Meanwhile, the paper feeding unit 13 is provided with a cassette 50 that accommodates a large number of sheets P, which are recording mediums, and a pick-up roller 51 that picks up the sheet P from the cassette 50. A plurality of cassettes 50 and a plurality of pick-up rollers 51 may be disposed to accommodate sheets P with different sizes, for example. In addition, the paper feeding unit 13 is provided with a manual insertion tray 52 through which the sheet P is supplied separately from the cassette 50. The paper feeding unit 13 transports the sheet P from the cassette 50 or the manual insertion tray 52 to a secondary transfer position by using a resist roller 53 and a plurality of pairs of transportation rollers 54. The sheet P is transported to the secondary transfer position in synchronization with the toner image transferred to the transfer belt 21.

The operation unit 14 is provided with a display screen as a user interface, operation buttons for various functions that can be performed by the image forming apparatus 10, or the like. The operation unit 14 is, for example, configured of a touch panel or the like. A user can select a job of forming an image containing a photoluminescent pigment (hereinafter, referred to as a “photoluminescent image”) through the operation unit 14. In addition, the user can select a job of forming a photoluminescent image through the external device connected via the interface.

The operation controller 15 controls the operation of the entire apparatus such that various processes in the image formation are performed. The operation controller 15 realizes various control functions with a CPU executing a program stored in, for example, a memory and causes the image forming apparatus 10 to perform an image forming process. The memory stores the program, various data used for the image forming process, or the like.

The image forming apparatus 10 forms any one of a monochrome image, a color image, and a photoluminescent image or a combination thereof on a surface of the sheet P according to user's selection. However, the image forming apparatus 10 may be an apparatus in which a component related to color toner is not provided and that forms any one of a monochrome image and a photoluminescent image or a combination thereof. Furthermore, the image forming apparatus 10 may be a device dedicated for forming a photoluminescent image. In addition, the image forming apparatus 10 is not limited to the MFP. Other examples of the image forming apparatus 10 include a copier, a printer, or the like. Furthermore, an image forming system is also not limited to the tandem system.

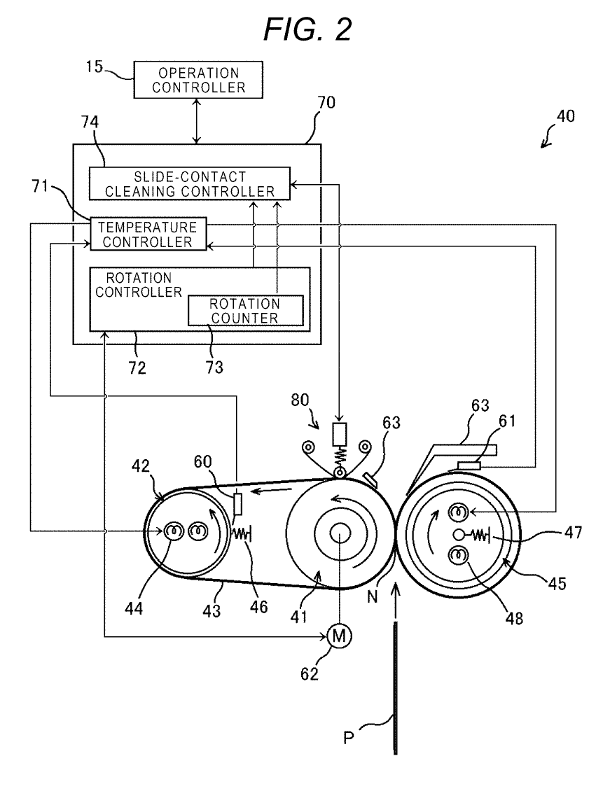

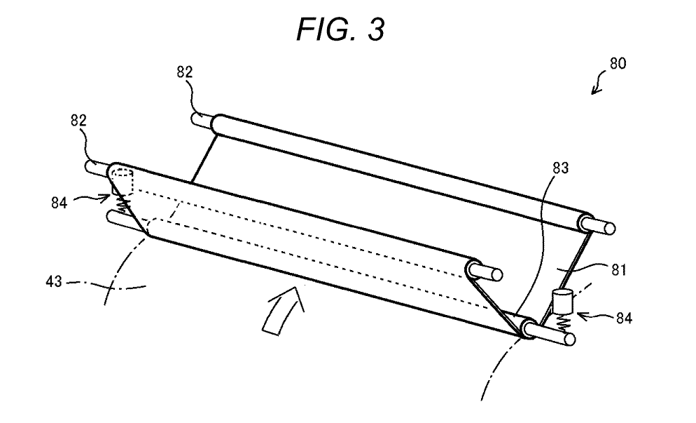

Next, the fixing device 40 in the first embodiment will be described with reference to FIGS. 2 to 3. FIG. 2 is a schematic configuration view of the fixing device 40 as seen from a lateral side and FIG. 3 is a perspective view of a slide-contacting member 80 provided in the fixing device 40 as seen from a front side.

The fixing device 40 is provided with a fixing member that heats a sheet with a toner image formed thereon and a pressing member that presses the sheet with the toner image formed thereon. The fixing member is configured of a fixing roller 41, a satellite roller 42, a fixing belt 43, and a heater 44 as a heat source, for example. In addition, the pressing member is configured of a pressing roller 45, for example.

The fixing roller 41 and the satellite roller 42 are disposed to be separated from each other. The endless fixing belt 43 is stretched between the fixing roller 41 and the satellite roller 42 and can continuously rotate along with the fixing roller 41 and the satellite roller 42. Furthermore, the satellite roller 42 is urged away from the fixing roller 41 by a tension device 46 and applies a tensile force to the fixing belt 43. The tension device 46 is, for example, a spring.

The pressing roller 45 is disposed to face the fixing roller 41 with the fixing belt 43 interposed therebetween. Furthermore, the pressing roller 45 is urged by a pressing device 47 in a direction to come into press-contact with the fixing roller 41 and forms a nip section N with a predetermined width between the fixing roller 41 and the pressing roller 45. The pressing device 47 is, for example, a spring.

The heater 44 as the heat source is disposed in a region inside the satellite roller 42 and heats the fixing belt 43 by means of heat transmission via the satellite roller 42, for example. The heater 44 is, for example, a halogen lamp. However, the heater 44 is not limited to the halogen lamp and may be an electromagnetic induction heater. An electromagnetic induction coil of the electromagnetic induction heater is disposed above a surface of the fixing belt and the electromagnetic induction heater heats the fixing belt 43 by means of electromagnetic induction. In addition, a heater 48 such as a halogen lamp may also be disposed in a region inside the pressing roller 45.

A temperature sensor 60 for temperature control is disposed close to an outer circumferential portion of the satellite roller 42. The temperature sensor 60 is, for example, a non-contact type thermistor. A fixing process controller 70 that controls the operation of the fixing device 40 is provided with a temperature controller 71. The temperature controller 71 controls the heater 44 such that the temperature of the surface of the fixing belt 43 is maintained at a necessary fixation temperature and the temperature detected by the temperature sensor 60 becomes a predetermined temperature. If the heater 48 is disposed on the pressing roller 45 side also, a temperature sensor 61 for temperature control is disposed close to an outer circumferential portion of the pressing roller 45. The temperature sensor 61 is, for example, a non-contact type thermistor. Even in this case, the temperature controller 71 controls the heater 48 such that the temperature detected by the temperature sensor 61 becomes a predetermined temperature.

The fixing process controller 70 is provided with a rotation controller 72, a rotation counter 73, and a slide-contact cleaning controller 74, which will be described later, in addition to the temperature controller 71. The fixing process controller 70 controls the operation of the entire apparatus such that each controller and each component performs the fixing process. The fixing process controller 70 realizes various control functions with a CPU executing a program stored in, for example, a memory and causes the fixing device 40 to perform the fixing process. The memory stores the program, various data used for the fixing process, or the like. Note that, the fixing process controller 70 may be configured of a CPU or the like that constitutes the operation controller 15.

Furthermore, the fixing roller 41 is connected to a drive motor 62, which is an example of a driving device, via a rotation gear or the like (not shown) and rotates in a direction illustrated by an arrow due to a driving force of the drive motor 62. The fixing belt 43 and the pressing roller 45 rotate in a direction illustrated by arrows in accordance with the rotation of the fixing roller 41. The satellite roller 42 rotates in accordance with the rotation of the fixing belt 43. The fixing process controller 70 that controls the operation of the fixing device 40 is provided with the rotation controller 72. The rotation controller 72 controls the drive motor 62 to start or to stop. However, not only the fixing roller 41 may be rotated by the drive motor 62 and, but also, for example, the pressing roller 45 may be rotated by the drive motor 62.

The rotation controller 72 is provided with the rotation counter 73. The rotation counter 73 detects the number of times of rotation of the fixing belt 43 from, for example, the time for which the drive motor 62 is driven or the number of times of rotation of the drive motor 62. Although detailed description will be made later, the rotation counter 73 counts the number of times that the fixing belt 43 rotates in a state where the slide-contacting member 80 is urged toward the surface of the fixing belt 43. As a modification example, a rotation sensor that detects rotation of the fixing belt 43 maybe disposed close to, for example, the surface of the fixing belt 43 and the number of times of rotation of the fixing belt 43 detected by the rotation sensor may be counted. As the rotation sensor, for example, a non-contact type rotation sensor such as an infrared rotation sensor, a roller encoder, or the like is used.

The fixing roller 41 is, for example, a roller which is a laminate obtained by coating an outer circumferential portion of a core metal having a rotation shaft with an elastic layer having a thickness of 8 mm. The core metal is, for example, a cylindrical metal member having a thickness of 2 mm. The elastic layer is, for example, foamed rubber (sponge). The surface hardness of the elastic layer is, for example, 40°. The outer diameter of the fixing roller 41 is, for example, 38 to 48.5 mm.

The satellite roller 42 is, for example, a roller which is a laminate obtained by forming a coating having a thickness of 30 μm on an outer circumferential surface of a metal pipe having a thickness of 2 mm. The material of the metal pipe is, for example, metal such as aluminum, iron, copper, and stainless steel. Furthermore, a heat pipe may be disposed inside the metal pipe as a material with a high thermal conductivity. Alternatively, the heat pipe may be used instead of the metal pipe. The coating is, for example, a release layer obtained by coating the outer circumferential surface of the metal pipe with polytetrafluoroethylene (PFA). The outer diameter of the satellite roller 42 is, for example, 17 to 38 mm.

The fixing belt 43 is, for example, a belt with a laminated structure obtained by subsequently laminating a solid rubber layer having a thickness of 200 μm and a release layer having a thickness of 30 μm on an upper surface of a metal layer having a thickness of 40 μm. The material of the metal layer is, for example, nickel, stainless steel, aluminum, or a composite material of stainless steel and aluminum. The solid rubber layer is, for example, silicon rubber. The release layer is formed of, for example, resin material. The resin is, for example, fluorine-based resin. The fluorine-based resin is, for example, PFA, polytetrafluoroethylene (PTFE), or the like. For example, cylindrical flexible materials with different outer diameters are used as the metal layer, the solid rubber layer and the release layer and the materials are concentrically overlapped each other to achieve a cylindrical laminate. The outer diameter of the fixing belt 43 measured after removing the fixing belt 43 from the fixing device 40 and causing the fixing belt 43 to have a cylindrical shape is, for example, equal to or greater than 30 mm.

The pressing roller 45 is, for example, a roller which is a laminate obtained by subsequently coating an outer circumferential surface of a core metal with an elastic layer having a thickness of 2 mm and a release layer having a thickness of 30 μm. The core metal is, for example, a cylindrical metal member having a thickness of 2 mm. The elastic layer is, for example, a rubber material such as silicon rubber and fluororubber. The release layer is, for example, PFA. The outer diameter of the pressing roller 45 is, for example, 40 to 50 mm.

Peeling plates 63 that peel off the sheet P passing through the nip section N are disposed in the vicinity of the surfaces of the fixing belt 43 and the pressing roller 45, respectively. The sheet P with a toner image that is formed on the surface thereof in the secondary transfer is transported being nipped the fixing belt 43 and the pressing roller 45 rotating and is heated and pressed when the sheet P passes through the nip section N. The toner image is melted and pressure-welded to the surface of the sheet P due to the application of heat and pressure.

In a case of the sheet P with a toner image containing a photoluminescent pigment that is formed on the surface thereof also, the toner image is melted and pressure-welded to the surface of the sheet P due to the application of heat and pressure. However, every photoluminescent pigment has a large particle diameter in comparison with usual toner and a photoluminescent pigment has a flat shape or a flake-like shape in many cases. In addition, in order to exhibit the luster, it is desirable that fixation is performed such that a flat surface of a photoluminescent pigment becomes parallel to the surface of the sheet P. The fixing process of applying heat and pressure has an effect of laying a photoluminescent pigment that is not parallel to the surface of the sheet P in the secondary transfer such that the photoluminescent pigment becomes parallel to the surface of the sheet P. Meanwhile, a photoluminescent pigment may damage the surface of the fixing belt 43, specifically, a surface of the release layer and may stick into the surface in some cases. Particularly, a photoluminescent pigment having a scale-like shape is likely to damage the surface of the fixing belt 43.

Therefore, the fixing device 40 is provided with the slide-contacting member 80 that performs slide-contact cleaning with respect to the surface of the fixing belt 43 after the sheet P with a toner image containing a photoluminescent pigment that is formed on the surface thereof passes through the nip section N. The slide-contact cleaning is a cleaning operation of removing toner via slide-contact and recovers the damaged surface of the fixing belt 43 via the slide-contact if the toner contains a photoluminescent pigment and is offset. Therefore, the slide-contacting member 80 is urged to such an extent that the slide-contacting member 80 comes into slide-contact with the surface of the rotating fixing belt 43 with friction. The slide-contacting member 80 is preferably disposed on the downstream side of the nip section N in a rotation direction of the fixing belt 43 such that the slide-contacting member 80 comes into contact with a portion of the surface of the fixing belt 43 before the portion comes into contact with the satellite roller 42 and is heated. For example, the slide-contacting member 80 is disposed on the downstream side of the nip section N to face the surface of the fixing roller 41 with the fixing belt 43 interposed therebetween. However, the number of slide-contacting members 80 and the installation position thereof can be changed.

FIG. 3 illustrates an example of a configuration of the slide-contacting member 80. The slide-contacting member 80 is provided with a sheet-shaped slide-contacting member 81 of which a curved surface comes into contact with the surface of the fixing belt 43. Furthermore, the slide-contacting member 80 is provided with a pair of supporting members 82 and an urging member 83. The pair of supporting members 82 supports front and rear ends of the sheet-shaped slide-contacting member 81. The urging member 83 urges the central portion of the sheet-shaped slide-contacting member 81 supported by the pair of supporting members 82 toward the surface of the fixing belt 43. The central portion refers to any portion of the sheet-shaped slide-contacting member 81 between the pair of supporting members 82. The pair of supporting members 82 and the urging member 83 are arranged to be parallel to a width direction of the surface of the fixing belt 43. The pair of supporting members and the urging member 83 pull the sheet-shaped slide-contacting member 81 to apply a tensile force and urge the sheet-shaped slide-contacting member 81 toward the surface of the fixing belt 43. That is, the slide-contacting member 80 urges a belt-shaped slide-contacting surface that extends in the width direction of the surface of the fixing belt 43 toward the surface of the fixing belt 43. However, the shape or the dimension of the belt-shaped slide-contacting surface can be changed.

The slide-contacting surface of the sheet-shaped slide-contacting member 81 that is urged toward the surface of the fixing belt 43 contains, for example, fiber material. The sheet-shaped slide-contacting member 81 is, for example, a nonwoven fabric, felt, a woven fabric, or the like. Among these, a nonwoven fabric or felt is preferable. Note that, the sheet-shaped slide-contacting member 81 may have a laminated structure obtained by laminating another member on a surface opposite to the slide-contacting surface.

The width of the sheet-shaped slide-contacting member 81 is equal to or greater than the width of the surface of the fixing belt 43 (particularly, a surface that comes into contact with the largest sheet in the fixing process). The thickness of the sheet-shaped slide-contacting member 81 is, for example, 2 mm. However, the dimension of the sheet-shaped slide-contacting member 81 can be appropriately changed.

Opposite ends of the urging member 83 are supported by urging devices 84. The urging devices 84 move the urging member 83 in a direction in which the urging member 83 is urged toward the surface of the fixing belt 43 when the slide-contact cleaning is performed and move the urging member 83 in a direction the urging member 83 is separated from the surface when the slide-contact cleaning is not performed. Each urging device 84 is, for example, a spring, a cylinder, a cam, an actuator, or the like. Among these, the spring is preferable. The urging device 84 may withdraw the urging member 83 such that a surface of the sheet-shaped slide-contacting member 81 is completely separated from the surface of the fixing belt 43 when the slide-contact cleaning is not performed. Alternatively, the urging member 83 may come into contact with the fixing belt 43 with the surface of the sheet-shaped slide-contacting member 81 being not completely separated from the surface of the fixing belt 43 and the urging member 83 being urged by a lower urging force rather than performing the slide-contact cleaning, for example. However, it is preferable that the surface of the sheet-shaped slide-contacting member 81 is completely separated from the surface of the fixing belt 43 since it is possible to reduce wear of the slide-contacting member 80 or the like.

The pair of supporting members 82 fixes and supports the front and rear ends of the sheet-shaped slide-contacting member 81. In addition, for example, when the supporting member 82 on the rear end side (the downstream side of an arrow in FIG. 3) is rotated with the length of the sheet-shaped slide-contacting member 81 being set to belong, the sheet-shaped slide-contacting member 81 is repeatedly wound onto the supporting member 82 on the rear end side. The opposite ends of the pair of supporting members 82 are supported by, for example, a casing or the like (not shown) that serves as an outer frame of the fixing device 40 and can rotate in the same direction or opposite directions. That is, when moving the urging member 83 such that the state of the urging member 83 transitions into an urged state from a state of being separated from the fixing belt 43, the pair of supporting members 82 rotates in the opposite directions to adjust the tensile force to the sheet-shaped slide-contacting member 81. In addition, if toner containing a photoluminescent pigment is accumulated on the slide-contacting surface or the slide-contacting surface is deteriorated due to, for example, the slide-contact cleaning being performed, the sheet-shaped slide-contacting member 81 is caused to move in a sliding manner by rotating the pair of supporting members 82 in synchronization in a direction in which the sheet-shaped slide-contacting member 81 is wound on the pair of supporting members 82 on the front end side such that a clean slide-contacting surface can be urged toward the fixing belt 43.

The urging member 83 and the pair of supporting members 82 are, for example, columnar members. The material of the urging member 83 and the pair of supporting members 82 is, for example, metal or resin material having a strength. An outer circumferential surface of the urging member 83 may be covered with a PFA release layer, for example. The outer diameters of the urging member 83 and the pair of supporting members 82 are, for example, 5 to 15 mm. The outer diameters of the urging member 83 and the pair of supporting members 82 may be equal to each other and may be different from each other.

The fixing process controller 70 that controls the operation of the fixing device 40 is provided with the slide-contact cleaning controller 74. The slide-contact cleaning controller 74 controls the slide-contacting member 80 to perform the slide-contact cleaning that satisfies a predetermined condition with respect to the surface of the fixing belt 43 when the sheet P on which a toner image containing a photoluminescent pigment is formed passes through the nip section N. The slide-contact cleaning is performed by rotating the fixing belt 43 with the slide-contacting member 80 being urged toward the surface of the fixing belt 43.

The slide-contacting member 80 is urged toward the surface of the fixing belt 43, for example, before an upper end of the sheet P on which a toner image containing a photoluminescent pigment is formed passes through the nip section N. Alternatively, the slide-contacting member 80 is urged toward the surface of the fixing belt 43 when the image forming apparatus 10 starts a job of forming a photoluminescent image. Otherwise, the slide-contacting member 80 may be urged toward the surface of the fixing belt 43 after the entire sheet passes through the nip section N, but, former case is preferable since the fixing belt 43 may rotate a plurality of times while one sheet P completely passes through the nip section N. In addition, it is preferable the slide-contact cleaning is performed until, for example, an upper end of another sheet P on which a toner image containing a photoluminescent pigment is formed passes through the nip section N.

That is, it is preferable that the slide-contact cleaning is performed before the surface of the fixing belt 43, that has come into contact with a toner image containing a photoluminescent pigment formed on a preceding sheet P, comes into contact with a toner image containing a photoluminescent pigment in a following sheet P. If the slide-contact cleaning is performed for the above-described period of time, the fixing belt 43 damaged by a photoluminescent pigment is less likely to be further damaged by a photoluminescent pigment on another sheet P.

The slide-contact cleaning may be performed while performing a normal image (a color image or a monochrome image) fixing process in another job, may be performed by causing the fixing belt 43 to idly rotate when the fixing process is not performed, or may be performed by a combination thereof. The idle rotation may be performed in, for example, awaiting-for-job reception state and may be performed after temporarily stopping the start the next job. Furthermore, since the slide-contact cleaning can be performed without heating the fixing belt 43, the slide-contact cleaning may be performed when the apparatus is in a power saving mode.

It is preferable that the slide-contact cleaning is performed such that a predetermined condition is satisfied. Determination on whether the predetermined condition is satisfied or not is preferably performed by using the number of times of rotation of the fixing belt 43 as an index, for example. Specifically, it is determined that the condition is satisfied when the number of times that the fixing belt 43 rotates with the slide-contacting member 80 being urged toward the surface of the fixing belt 43 is, for example, equal to or greater than 40. However, as described above, since the slide-contact cleaning has various execution forms, the determination is preferably performed depending on whether a predetermined average value is reached or not. For example, if the slide-contact cleaning is performed during a period of time for which the normal image fixing process is performed and a job is terminated with the number of times of rotation being smaller than 40, the idle rotation is continued such that the number of times of rotation becomes equal to or greater than 40. That is, the slide-contact cleaning is performed such that the predetermined average value is reached.

As a modification example, the determination on whether the predetermined condition is satisfied or not may be performed by using a period of time for which the slide-contact cleaning is performed as an index. In addition, the number of sheets P with normal images that are subject to the fixing process with the slide-contacting member 80 being urged toward the surface of the fixing belt 43 may be used as an index. That is, the determination may be performed using any index as long as the slide-contact cleaning may be performed such that the predetermined average value is reached. However, since the number of times of rotation of the fixing belt 43 is a more stable as an index, it is preferable that the determination is performed by using the number of times of rotation finally while converting time into the number of times of rotation or converting the number of sheets P subject to the fixing process into the number of times of rotation.

As described above, the rotation counter 73 counts the number of times that the fixing belt 43 rotates with the slide-contacting member 80 being urged toward the surface of the fixing belt 43. Furthermore, if the number of times of rotation of the fixing belt 43 is equal to or greater than 40, which is an example of the predetermined average value, the rotation counter 73 sets, for example, a flag indicating that the slide-contact cleaning is finished such that whether a job of forming a photoluminescent image can be started or not can be determined. If the number of times of rotation is not equal to or greater than 40, the rotation counter 73 continues count until the number of times of rotation becomes equal to or greater than 40. Furthermore, when toner containing a photoluminescent pigment passes through the nip section N, the rotation counter 73 resets the count and sets, for example, a flag indicating that the slide-contact cleaning is not finished such that whether a job of forming a photoluminescent image can be started or not can be determined.

Subsequently, an example of toner containing a photoluminescent pigment will be described.

Toner containing a photoluminescent pigment is toner containing at least a photoluminescent pigment as a colorant and binder resin. As the photoluminescent pigment, a scale-shaped pigment is used, for example. The shape thereof is not limited to a scale-like shape. Examples of photoluminescent pigment particles include metal powders such as aluminum powders, brass powders, bronze powders, nickel powders, stainless steel powders, and zinc powders, mica coated with a titanium oxide or a yellow iron oxide, a flaky inorganic crystalline substrate coated with barium sulfate, layered silicate, and silicate of layered aluminum, or the like, a single-crystal plate-like titanium oxide, a basic carbonate, bismuth oxychloride, natural guanine, flaky glass powders, and metal-deposited flaky glass powders.

As a photoluminescent pigment, a particle having a volume average particle diameter of 6 μm to 100 μm is used, for example. The volume average particle diameter is measured by, for example, a coulter counting method. It is preferable that a particle having a volume average particle diameter of 6 μm to 100 μm is used since the photoluminescence properties become favorable and it becomes possible to stably perform image formation control in the image forming apparatus. If the volume average particle diameter is smaller than 6 μm, there is a case where photoluminescence properties become not sufficient. In addition, if the volume average particle diameter exceeds 100 μm, there is a case where it is not possible to stably perform the image formation control such as development or transfer.

Examples of the binder resin include polyester, styrene acrylic, polyurethane, epoxy resin, or the like. As the polyester, for example, as a raw material monomer of the polyester, an alcohol component having a valence of 2 or more, a carboxylic acid component such as carboxylic acid having a valence of 2 or more, carboxylic anhydride, or carboxylate ester, or the like is used. As the styrene/acrylic, for example, polymers of styrenes, copolymers of styrenes and dienes, copolymers of styrenes and alkyl (meth) acrylates, or the like are used.

If wax is used for the toner containing the photoluminescent pigment, aliphatic hydrocarbon-based wax such as low molecular weight polyethylene, low molecular weight polypropylene, a polyolefin copolymer, polyolefin wax, microcrystalline wax, paraffin wax, or Fischer-Tropsch wax, an oxide of aliphatic hydrocarbon-based wax such as oxidized polyethylene wax, a block copolymer thereof, vegetable wax such as candelilla wax, carnauba wax, japan wax, jojoba wax, or rice wax, animal wax such as beeswax, lanolin, or spermaceti, mineral wax such as ozocerite, ceresin, or petrolatum; wax including fatty acid ester as a main component such as montanic acid ester wax, or castor wax, or a material obtained by deoxidizing a part of or entire fatty acid ester such as deoxidized carnauba wax, is used as the wax.

If an electrification control agent is used for the toner containing the photoluminescent pigment, as the charge control agent, for example, a metal-containing azo compound is used. The metallic element of the metal-containing azo compound is preferably, for example, iron, cobalt, a chromium complex, a complex salt, or a mixture thereof. In addition, as another example of the charge control agent, for example, a metal-containing salicylic acid derivative compound is used. The metallic element of the metal-containing salicylic acid derivative compound is preferably, zirconium, zinc, chromium, a boron complex, a complex salt, or a mixture thereof.

Inorganic fine particles may be externally added and mixed into the toner containing the photoluminescent pigment. As the inorganic fine particles, for example, one or a mixture of two or more of silica, titania, alumina, strontium titanate, tin oxide is used. The inorganic fine particles, are preferably used after being subject to the surface treatment using a hydrophobing agent. In addition, resin fine particles of which the particle diameter is equal to or smaller than 1 μm may be added in addition to the inorganic oxide.

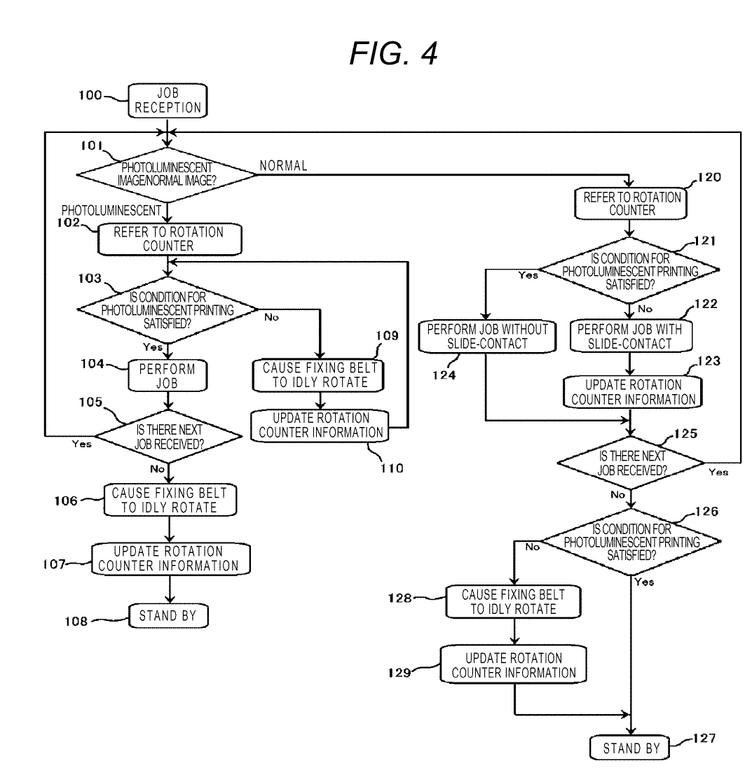

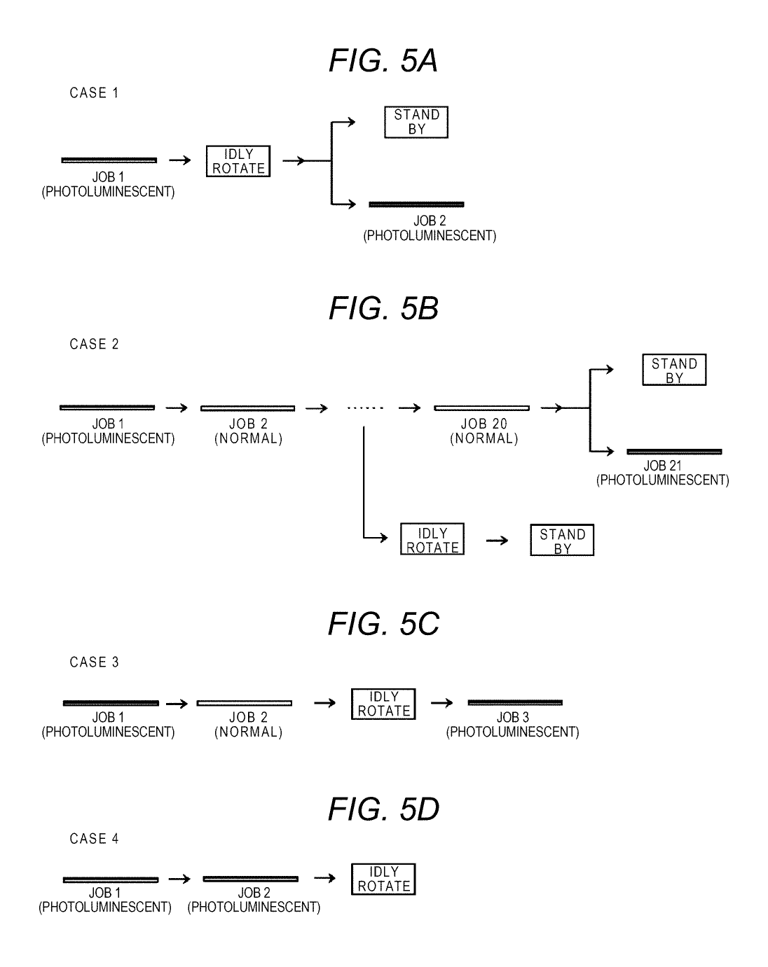

Subsequently, the flow of the slide-contact cleaning performed by the above-described fixing device 40 will be described with reference to FIGS. 4 to 5D. FIG. 4 is a flowchart illustrating the flow of a process. FIGS. 5A to 5D illustrate an example of an execution form of the slide-contact cleaning in a patterned manner.

The flow of the process will be described with reference to a case 1 in FIG. 5A. First, for example, if a job 1 is received in an initial state after the apparatus is started (a state where the slide-contact cleaning is finished) (Act 100), the fixing process controller 70 determines whether the job 1 is a job of forming a photoluminescent image or a normal image (Act 101). Since the job 1 is a job of forming a photoluminescent image (PHOTOLUMINESCENT in Act 101), the fixing process controller 70 refers to the rotation counter 73 (Act 102). Since the slide-contact cleaning is finished in this case, the fixing process controller 70 determines that a condition for forming a photoluminescent image is satisfied (Yes in Act 103) and performs a job of forming a photoluminescent image (Act 104). When the job of forming a photoluminescent image is performed, the count of the rotation counter 73 is reset and a slide-contact cleaning unfinished state is entered.

Subsequently, the fixing process controller 70 checks whether or not a next job is received (Act 105). For example, if the next job 2 is not received yet, the fixing process controller 70 determines that, the next job is not received (No in Act 105) and causes the fixing belt 43 to idly rotate to perform the slide-contact cleaning (Act 106). When the slide-contact cleaning is performed with the idle rotation and the count of the rotation counter 73 becomes equal to or greater than a predetermined number, the slide-contact cleaning is terminated (Act 107) and a standby state is entered (Act 108).

If it is determined that the next job 2 is received in Act 105 (Yes in Act 105), the fixing process controller 70 determines whether the next job is a job of forming a photoluminescent image or a normal image (Act 101). Since the job 2 is a job of forming a photoluminescent image, (PHOTOLUMINESCENT in Act 101), the fixing process controller 70 refers to the rotation counter 73 (Act 102). The count of the rotation counter 73 is reset due to the job 1 and the slide-contact cleaning unfinished state is entered. Therefore, the fixing process controller 70 determines that the condition for forming a photoluminescent image is not satisfied (No in Act 103) and causes the fixing belt 43 to idly rotate to perform the slide-contact cleaning without performing the job 2 (Act 109). When the slide-contact cleaning is performed with the idle rotation and the count of the rotation counter 73 becomes equal to or greater than the predetermined number, the slide-contact cleaning is terminated (Act 110). Then, it is determined that the condition for forming a photoluminescent image is satisfied (Yes in Act 103) and the job 2 is performed (Act 104).

Subsequently, the flow of the process will be described with reference to a case 2 in FIG. 5B.

If the job 1 is performed as described above (Act 100 to Act 104) and the next job 2 is received (Yes in Act 105), the fixing process controller 70 determines whether the next job is a job of forming a photoluminescent image or a normal image (Act 101). Since the job 2 is a job of forming a normal image (NORMAL in Act 101), the fixing process controller 70 refers to the rotation counter (Act 120) and determines whether the condition for forming the photoluminescent image is satisfied or not (Act 121). In this case, the count of the rotation counter 73 is reset due to the job 1 and the slide-contact cleaning unfinished state is entered. Therefore, the fixing process controller 70 performs the slide-contact cleaning while performing the job 2 of forming a normal image (Act 122 and Act 123) since the condition for forming the photoluminescent image is not satisfied (No in Act 121). If there is no job 1, the condition for forming the photoluminescent image is satisfied at this time (Yes in Act 121) and thus the fixing process controller 70 performs only the job 2 without performing the slide-contact cleaning (Act 124).

If the job 2 is performed with the slide-contact cleaning being performed and jobs 3 to 20 are performed with the slide-contact cleaning being performed as with the job 2 (Act 101 to Act 123), the count of the rotation counter 73 becomes equal to or greater than the predetermined number. In this case, if a job 21 of forming a photoluminescent image is received after the job 20 (Yes in Act 125), the job 21 is immediately performed without temporary stoppage (Act 101 to Act 104).

Meanwhile, if the next job is not received after the job 20 is performed (No in Act 125), the fixing process controller determines whether the condition for forming the photoluminescent image is satisfied (Act 126). In this case, since the slide-contact cleaning is finished, the fixing process controller 70 determines that the condition for forming a photoluminescent image is satisfied (Yes in Act 126) and enters a standby state (Act 127). Note that, if the number of jobs of forming a normal image is small and it is determined that the condition for forming the photoluminescent image is not satisfied in Act 126, the fixing process controller 70 causes the fixing belt 43 to idly rotate to perform the slide-contact cleaning (Act 128). When the slide-contact cleaning is performed with the idle rotation and the count of the rotation counter 73 becomes equal to or greater than the predetermined number, the slide-contact cleaning is terminated (Act 129) and a standby state is entered (Act 127).

Subsequently, the flow of the process will be described with reference to a case 3 in FIG. 5C.

If the job 1 is performed as described above (Act 100 to Act 104) and the next job 2 is received (Yes in Act 105), the fixing process controller 70 determines whether the next job is a job of forming a photoluminescent image or a normal image (Act 101). Since the job 2 is a job of forming a normal image (NORMAL in Act 101), the fixing process controller 70 refers to the rotation counter (Act 120) and determines whether the condition for forming the photoluminescent image is satisfied or not (Act 121). In this case, the count of the rotation counter 73 is reset due to the job 1 and the slide-contact cleaning unfinished state is entered. Therefore, the fixing process controller 70 performs the slide-contact cleaning while performing the job 2 of forming a normal image (Act 122 and Act 123) since the condition for forming the photoluminescent image is not satisfied (No in Act 121).

If it is determined that the next job 3 is received in Act 125 (Yes in Act 125), the fixing process controller 70 determines whether the next job is a job of forming a photoluminescent image or a normal image (Act 101). Since the job 3 is a job of forming a photoluminescent image, (PHOTOLUMINESCENT in Act 101), the fixing process controller 70 refers to the rotation counter 73 (Act 102). The number of rotation counted by the rotation counter 73 does not reach the predetermined number while the slide-contact cleaning is performed in the job 2. Therefore, the fixing process controller 70 determines that the condition for forming a photoluminescent image is not satisfied (No in Act 103) and causes the fixing belt 43 to idly rotate to perform the slide-contact cleaning without performing the job 3 (Act 109). When the slide-contact cleaning is performed with the idle rotation and the count of the rotation counter 73 becomes equal to or greater than the predetermined number, the slide-contact cleaning is terminated (Act 110). Then, it is determined that the condition for forming a photoluminescent image is satisfied (Yes in Act 103) and the job 3 is performed (Act 104).

Note that, as one of modification examples, printing of photoluminescent images may be consecutively performed a predetermined number of times (on a predetermined number of sheets). As exemplified in FIG. 5D, the two jobs 1 and 2 (for two sheets) may be consecutive jobs of printing photoluminescent images. That is, a predetermined number of sheets P on which printing is performed by using photoluminescent toner is regarded as one sheet P for convenience and the slide-contact cleaning is performed until sheets P, of which the number exceeds the predetermined number, pass through the nip section N. However, it is preferable to perform the slide-contact cleaning with respect to one job (one sheet) as described above in view of preventing toner offset from entering the nip section N again and preventing the fixing belt 43 from being further damaged. The number of sheets that are regarded as one sheet may be set according to an image-formed region occupied by photoluminescent toner in the surface of the sheet P, such as a printing rate. In addition, if the number of times of printing exceeds the number of sheets that are regarded as one sheet, the printing is temporarily stopped even in the middle of a printing job and the printing is restarted after the slide-contact cleaning is performed. That is, the number of times of actually necessary slide-contact cleaning is secured by means of a temporal stopping process.

### Second Embodiment

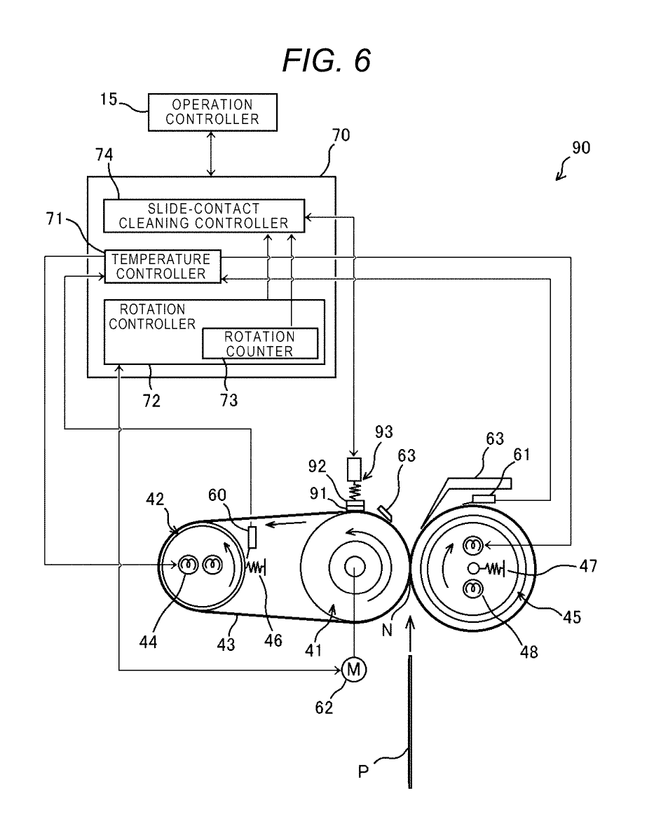

Subsequently, a fixing device 90 in a second embodiment will be described with reference to FIG. 6. FIG. 6 is a schematic configuration view of the fixing device 90 in the second embodiment as seen from a lateral side. Note that, the same components as in the fixing device 40 in the first embodiment are given the same reference numerals and detailed description thereof will be omitted.

The second embodiment is a modification example of the above-described first embodiment. The fixing device 90 in the second embodiment includes a flat slide-contacting member 91 instead of the slide-contacting member 80 illustrated in FIG. 3. The width of the flat slide-contacting member 91 is equal to or greater than the width of the surface of the fixing belt 43. The thickness of the flat slide-contacting member 91 is, for example, 2 mm. The length of the flat slide-contacting member 91 in a front-rear direction is, for example, 15 mm. However, the dimension of the flat slide-contacting member 91 can be appropriately changed.

An urging member 92 having a strength is stacked on an upper surface of the flat slide-contacting member 91 and an urging device 93 is disposed close to the upper surface, for example. The material of the urging member 92 is, for example, metal or resin material having a strength. The material of the flat slide-contacting member 91 is the same as that of the sheet-shaped slide-contacting member 81 in the first embodiment. Third Embodiment

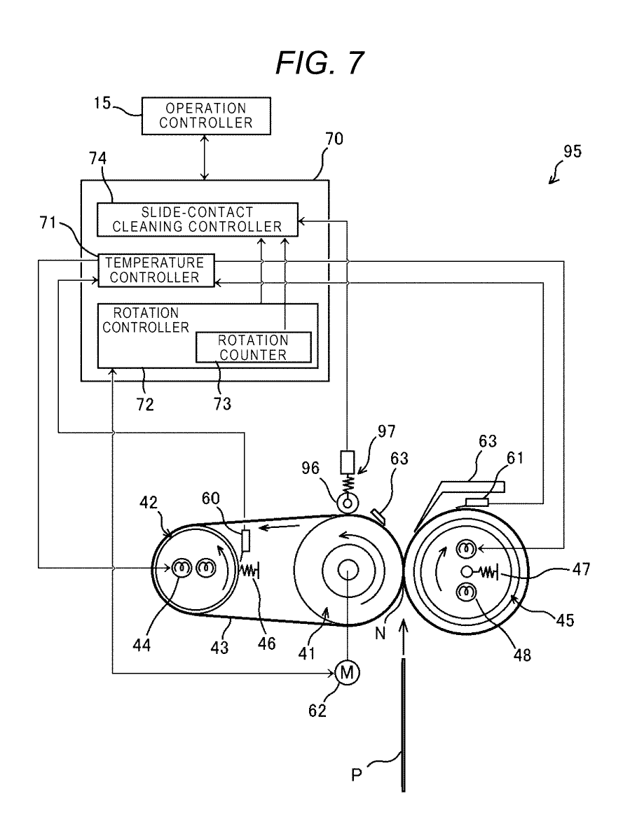

Subsequently, a fixing device 95 in a third embodiment will be described with reference to FIG. 7. FIG. 7 is a schematic configuration view of the fixing device 95 in the third embodiment as seen from a lateral side. Note that, the same components as in the fixing device 40 in the first embodiment are given the same reference numerals and detailed description thereof will be omitted.

The third embodiment is a modification example of the above-described first embodiment. The fixing device 95 in the third embodiment includes a roll-shaped slide-contacting member 96 instead of the slide-contacting member 80 illustrated in FIG. 3. The width of the roll-shaped slide-contacting member 96 is equal to or greater than the width of the surface of the fixing belt 43. The outer diameter of the roll-shaped slide-contacting member 96 is, for example, 5 to 15 mm. However, the dimension of the roll-shaped slide-contacting member 96 can be appropriately changed.

The roll-shaped slide-contacting member 96 is, for example, a laminate obtained by coating an outer circumferential portion of a columnar core with a slide-contacting member. Furthermore, urging devices 97 are disposed at the opposite ends of the core. The material of the core is, for example, metal or resin material having a strength. The material of the roll-shaped slide-contacting member 96 is the same as that of the sheet-shaped slide-contacting member 81 in the first embodiment. Note that, if the roll-shaped slide-contacting member 96 rotates in accordance with rotation of the fixing belt 43, a slide-contacting effect cannot be achieved. Therefore, it is preferable that the roll-shaped slide-contacting member 96 does not rotate or rotates with a difference in relative speed with respect to the fixing belt 43.

According to at least one of the above-described embodiments, when the sheet P on which a toner image containing a photoluminescent pigment is formed passes through the nip section N, the slide-contact cleaning in which the fixing belt 43 is rotated with the slide-contacting members 80, 91, and 96 being urged is performed such that an offset photoluminescent pigment can be removed and the surface of the fixing belt 43 damaged by the photoluminescent pigment can be recovered.

If the offset photoluminescent pigment can be removed, it is possible to prevent the photoluminescent pigment from entering the nip section N again. In addition, if the surface of the fixing belt 43 damaged by the photoluminescent pigment can be recovered, it is possible to prevent a rough image from being formed in a following job.

According to at least one of the above-described embodiments, since the slide-contacting members 80, 91, 96, of which the slide-contacting surface contains fiber material, are used, it is possible to tie and capture a photoluminescent pigment offset on the surface of the fixing belt 43 (the photoluminescent pigment sticks into the surface in some cases) and to recover the damage caused by the photoluminescent pigment. The photoluminescent pigment captured by the slide-contacting members 80, 91, and 96 can be removed from the fixing device by replacing the slide-contacting members 80, 91, and 96. Accordingly, the usage time of the slide-contacting member 80 in FIG. 3, of which the sheet-shaped slide-contacting member 81 can be moved in a sliding manner, can be lengthened. Note that, a cloth-shaped member of which a side circumferential surface or the like of fiber comes into contact with the fixing belt is more preferable than a brush-shaped member of which the vicinity of a tip end of fiber comes into contact with the fixing belt 43. Meanwhile, in a case of rubber material or the like, for example, an effect of capturing a photoluminescent pigment is small in comparison with a fiber-shaped material although a recovery effect can be expected.

Note that, the configuration of the fixing member is not limited to a configuration provided with the fixing roller 41, the satellite roller 42, the fixing belt 43, and the heater 44.

### EXAMPLES

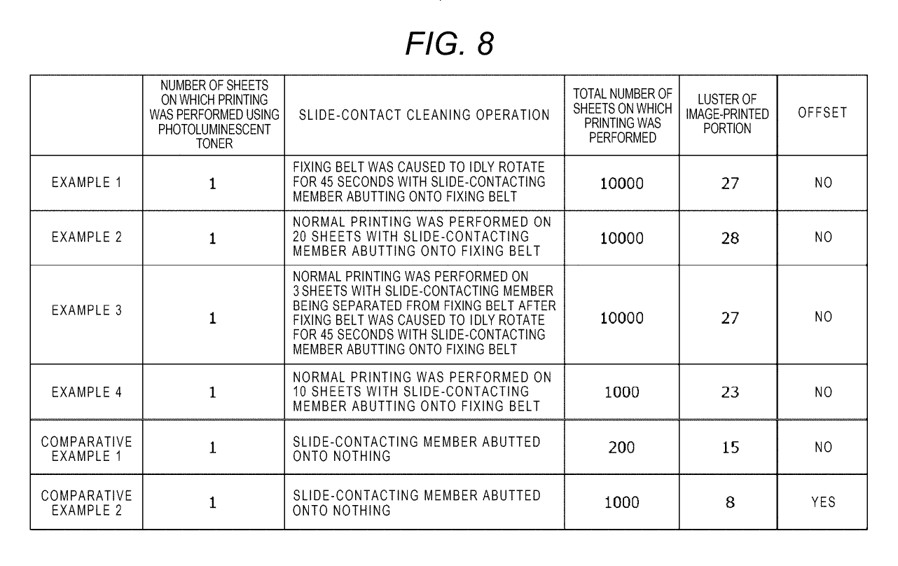

Subsequently, examples of the result of experiments performed in relation to the slide-contact cleaning will be described with reference to FIGS. 8 to 10.

### Preparation of Resin-Atomized Liquid

Resin-atomized liquid was obtained by inputting a dispersion obtained by mixing 30 parts by weight of the polyester resin of which the pH was adjusted to 12 using potassium hydroxide (acid value: 10 mgKOH/g, Mw 15000, Tg 58° C.), 1 part by weight of sodium dodecylbenzenesulfonate (NEOPELEX G15, produced by Kao Corporation), and 69 parts by weight of ion exchanged water in a high-pressure homogenizer NANO 3000 (produced by Beryu Co., Ltd.) and processing the dispersion at 150° C. and at 150 MPa. When the dispersion diameter of the obtained dispersion was measured using SALD-7000 manufactured by SHIMADZU CORPORATION, a sharp particle size distribution with a volume average particle diameter of 0.23 μm and with a standard deviation of 0.15 was obtained.

### Preparation of Wax-Atomized Liquid

A mixture was prepared by mixing 40 parts by weight of the ester wax, 4 parts by weight of sodium dodecylbenzenesulfonate serving as anionic surfactant, 1 part by weight of triethylamine serving as amine compound and 55 parts by weight of ion exchanged water in a CLEARMIX. Then, mechanical shearing was performed for 30 minutes with the rotation speed of the CLEARMIX being set to be 6000 rpm after the mixture was heated to 80° C. in the CLEARMIX. Wax-atomized liquid was obtained by cooling the mixture to a normal temperature after the mechanical shearing was finished. The volume average particle diameter was measured using SALD-7000 manufactured by SHIMADZU CORPORATION. As a result, it was found that the volume average particle diameter was 0.2 μm.

### Preparation of Resin-Wax Mixture

35 parts by weight of the resin-atomized liquid, 26 parts by weight of the wax-atomized liquid and 39 parts by weight of pure water were input in a flask and stirred to obtain a resin-wax mixture.

### Photoluminescent Pigment

For the photoluminescent pigment, Iriodin 305 produced by Merck Corporation was used as a mica-based pigment.

Preparation of Toner containing Photoluminescent Pigment

12 parts by weight of Iriodin 305 and 186 parts by weight of ion exchanged water were mixed and stirred while adding 7 parts by weight of 0.5% polydiallyl dimethyl ammonium chloride solution. The mixture was heated to 45° C., 5 parts by weight of 30% ammonium sulfate aqueous solution were added thereto, and the mixture was kept for 1 hour. Then, 29 parts by weight of the resin-wax mixture were dropped using a dropping funnel and 7.5 parts by weight of 30% ammonium sulfate aqueous solution were added thereto to encapsulate resin and wax in a pigment particle. Then, toner composition aggregate dispersion liquid was obtained by adding 26 parts by weight of 30% ammonium sulfate solution and gradually adding the mixture solution of 70 parts by weight of the resin-atomized liquid and 58 parts by weight of ion exchanged water for 15 hours. Furthermore, as surfactant, 5 parts by weight of a polycarboxylic acid-based surfactant (POIZ520, produced by Kao Corporation) were added into the toner composition aggregate dispersion liquid. The toner composition aggregate dispersion liquid was heated to 65° C. and left to obtain a toner dispersion and the obtained toner dispersion was repeatedly filtered and cleaned with ion exchanged water until the conductivity of the filtrate became 50 μs/cm. Thereafter, the toner dispersion was dried using a vacuum dryer until the water content became equal to or lower than 1.0 weight % to obtain a dried toner particle.

### Fixing Device

For the fixing device used in evaluation, a fixing belt having a laminated structure of 40 μm of electroformed nickel as a metal layer, 300 μm of silicon rubber on an outer circumferential surface thereof, and 30 μm of a PFA tube was used. As a satellite roller, a roller obtained by coating a surface of an aluminum core metal having an outer diameter of 38 mm and a thickness of 2 mm with 30 μm of a PFA tube was used. As a fixing roller, a roller having a rigidity of 40°, a sponge thickness of 8 mm, and a diameter of 38 mm was used and a 400-N spring was used as a tension device. As a pressing roller, a roller obtained by coating an iron core metal having an outer diameter of 40 mm and a thickness of 2 mm with 2 mm of rubber and coating the rubber with 30 μm of a PFA tube.

In addition, as a slide-contacting member, a member obtained by cutting a felt cloth having a thickness of 2.0 mm to have a width of 15 mm was used and the slide-contacting member was fixed such that the fixing belt could rotate with the slide-contacting member being urged toward the surface of the fixing belt.

### Evaluation

A two-component developer obtained by mixing a toner containing a scale-shaped photoluminescent pigment with a ferrite carrier coated with silicon resin such that a ratio concentration became 10% was input in an image forming apparatus (e-STUDIO 4520C, manufactured by TOSHIBA TEC CORPORATION), adjustment was performed such that an amount of toner attached on a paper sheet became 1.35 mg/cm², and a solid belt, of which the length was the same as the maximum transverse length of A4 sheet (approximately 200 mm), was printed under a condition under which image offset does not occur.

Thereafter, after a slide-contacting process was performed, a single-color solid image of normal cyan toner was printed on a sheet having a basis weight of 200 g such that the image concentration became 1.7 and determination on how a portion, on which the solid belt was printed using the toner containing the scale-shaped photoluminescent pigment, and a portion on which, no solid belt was printed, were different in luster and determination on whether the cyan toner was offset or not were performed. For luster measurement, a gloss checker IG-331, which is a luster meter manufactured by HORIBA, Ltd. (measurement angle: 60°), was used in luster measurement. FIG. 8 shows the results of evaluation on following Examples and Comparative Examples.

### Example 1

A photoluminescent image having a length of 200 mm and a width of 30 mm was printed on an A4-sized paper sheet having a basis weight of 64 g in a sub scanning direction with the slide-contacting member being urged and thereafter, a slide-contacting operation was performed by causing the fixing belt to idly rotate for 45 seconds. This operation was repeatedly performed and it was checked whether there was a difference in luster or offset after obtaining a single-color solid image formed by cyan toner when the operation was performed with respect to a predetermined number of sheets. As a result, the luster of an image-printed portion of the single-color solid image formed by cyan toner was 27 while the luster of a non-image-printed portion was 30 even after photoluminescent images were printed on 10000 sheets and thus it was substantially difficult to distinguish between the non-image-printed portion and the image-printed portion. There was no image offset. Note that, the number of times that the fixing belt rotated for a time for which the fixing belt was caused to idly rotate for 45 seconds was approximately 50.

### Example 2

A photoluminescent image having a length of 200 mm and a width of 30 mm was printed on an A4-sized paper sheet having a basis weight of 64 g in the sub scanning direction with the slide-contacting member being urged and thereafter, the slide-contacting operation was performed by performing a printing operation using normal toner with respect to 20 sheets with the slide-contacting member being urged. This operation was repeatedly performed and it was checked whether there was a difference in luster or offset after obtaining a single-color solid image formed by cyan toner when the operation was performed with respect to a predetermined number of sheets. As a result, the luster of an image-printed portion of the single-color solid image formed by cyan toner was 28 while the luster of a non-image-printed portion was 30 even after photoluminescent images were printed on 10000 sheets and thus it was substantially difficult to distinguish between the non-image-printed portion and the image-printed portion. There was no image offset. Note that, the number of times that the fixing belt rotated during printing on 20 sheets using normal toner was 40.

### Example 3

A photoluminescent image having a length of 200 mm and a width of 30 mm was printed on an A4-sized paper sheet having a basis weight of 64 g in the sub scanning direction with the slide-contacting member being urged and thereafter, the slide-contacting operation was performed by causing the fixing belt to idly rotate for 45 seconds. After that, a printing operation using normal toner was performed on three sheets with the slide-contacting member being separated. This operation was repeatedly performed and it was checked whether there was a difference in luster or offset after obtaining a single-color solid image formed by cyan toner when the operation was performed with respect to a predetermined number of sheets. As a result, the luster of an image-printed portion of the single-color solid image formed by cyan toner was 27 while the luster of a non-image-printed portion was 30 even after photoluminescent images were printed on 10000 sheets and thus it was substantially difficult to distinguish between the non-image-printed portion and the image-printed portion. There was no image offset. Note that, the number of times that the fixing belt rotated for a time for which the fixing belt was caused to idly rotate for 45 seconds was approximately 50.

### Example 4

A photoluminescent image having a length of 200 mm and a width of 30 mm was printed on an A4-sized paper sheet having a basis weight of 64 g in the sub scanning direction with the slide-contacting member being urged and thereafter, the slide-contacting operation was performed by repeating normal printing, in which a photoluminescent pigment was not used, on the same medium 10 times. After photoluminescent images were printed on 1000 sheets, it was checked whether there was a difference in luster or offset after obtaining a single-color solid image formed by cyan toner. As a result, the luster of an image-printed portion was decreased to 23 while the luster of a non-image-printed portion was 30. There was no cyan toner offset. Note that, the number of times that the fixing belt rotated during printing on 10 sheets using normal toner was 20.

### Comparative Example 1

A photoluminescent image having a length of 200 mm and a width of 30 mm was printed on an A4-sized paper sheet having a basis weight of 64 g in the sub scanning direction without using the slide-contacting member and the slide-contacting operation was not performed thereafter. After a photoluminescent image printing operation was performed 200 times, it was checked whether there was a difference in luster or offset after obtaining a single-color solid image formed by cyan toner. As a result, the luster of an image-printed portion was decreased to 15 while the luster of a non-image-printed portion was 30. There was no cyan toner offset.

### Comparative Example 2

A photoluminescent image having a length of 200 mm and a width of 30 mm was printed on an A4-sized paper sheet having a basis weight of 64 g in the sub scanning direction without using the slide-contacting member and the slide-contacting operation was not performed thereafter. After the photoluminescent image printing operation was performed 1000 times, it was checked whether there was a difference in luster or offset after obtaining a single-color solid image formed by cyan toner. As a result, the luster of an image-printed portion was decreased to 8 while the luster of a non-image-printed portion was 30. Furthermore, there was cyan toner offset.

### Example 5

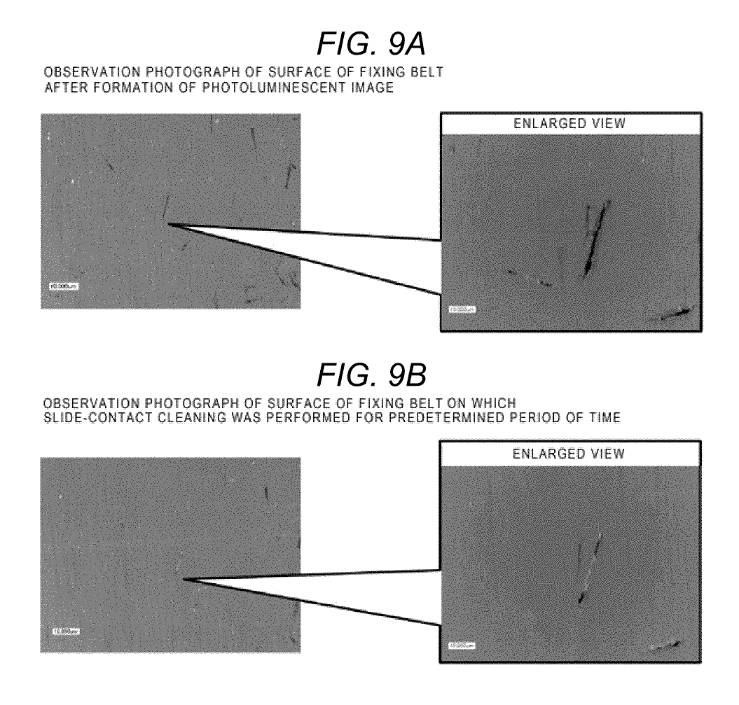

The state of the surface of the fixing belt was observed and checked after printing a photoluminescent image having a length of 200 mm and a width of 30 mm on an A4-sized paper sheet having a basis weight of 64 g in the sub scanning direction and performing the slide-contacting operation thereafter. The state of the surface of the fixing belt is shown in FIG. 9. It was found that the surface of the fixing belt was damaged due to printing of the photoluminescent image and the damage was backfilled and recovered through the slide-contacting operation performed.

### Example 6

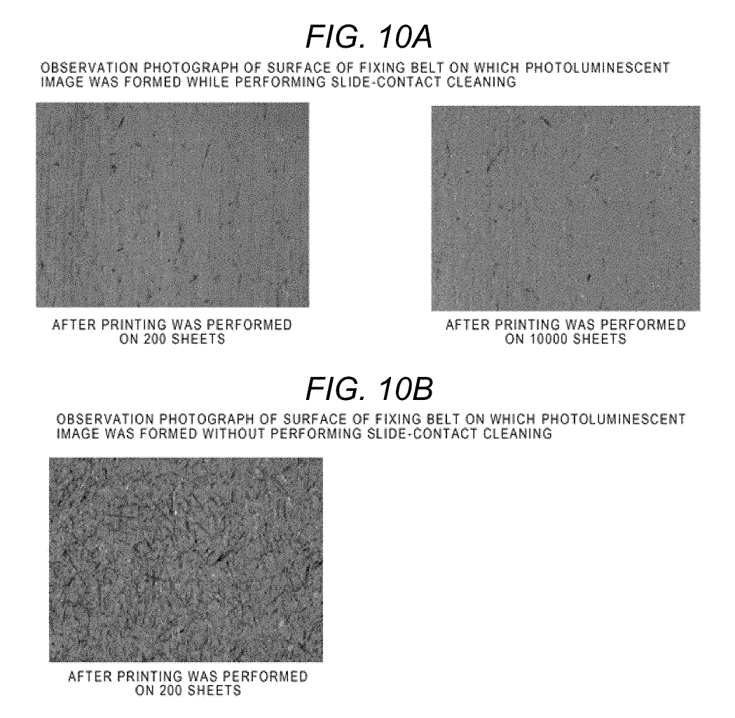

The state of the surface of the fixing belt was observed and checked after consecutively printing a photoluminescent image having a length of 200 mm and a width of 30 mm on an A4-sized paper sheet having a basis weight of 64 g in the sub scanning direction while performing the slide-contacting operation. For the purpose of comparison, the state of the surface of the fixing belt was observed and checked after consecutively printing a photoluminescent image having a length of 200 mm and a width of 30 mm on an A4-sized paper sheet having a basis weight of 64 g in the sub scanning direction without performing the slide-contacting operation. The state of the surface of the fixing belt is shown in FIG. 10. It was found that it is possible to suppress the degree of damage to the surface of the fixing belt by performing the slide-contacting operation even when photoluminescent images are consecutively printed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fixing device comprising:
a rotatable fixing member configured to heat a sheet, on which a toner image is formed, while rotating;
a rotatable pressing member press-contacting with the fixing member to form a nip section and configured to nip and transport the sheet while rotating with the fixing member; and
a slide-contacting member in contact with the fixing member and configured to slide-contact clean by urging a slide-contacting surface with respect to a surface of the fixing member when the sheet on which the toner image containing a photoluminescent pigment is formed, passes through the nip section.

2. The device according to claim 1, further comprising:
a controller configured to control the slide-contacting member and the fixing member such that the slide-contact cleaning is performed a predetermined number of times until a second sheet on which a toner image containing a photoluminescent pigment is formed, passes through the nip section.

3. The device according to claim 1, wherein the slide-contacting surface is belt-shaped and extends in a width direction of the surface of the fixing member, a controller is configured to control the fixing member such that the fixing member rotates at least a predetermined number of times, with the slide-contacting surface urged toward the surface of the fixing member.

4. The device according to claim 1, wherein the slide-contacting member comprises a sheet-shaped slide-contacting member, a pair of supporting members disposed along a width direction of the surface of the fixing member and configured to support front and rear ends of the sheet-shaped slide-contacting member, and an urging member disposed along the width direction of the surface of the fixing member and configured to urge a central portion of the sheet-shaped slide-contacting member toward the surface of the fixing member.

5. A fixing device comprising:
a rotatable fixing member configured to heat a sheet, on which a toner image is formed, while rotating;
a rotatable pressing member press-contacting with the fixing member to form a nip section and configured to nip and transport the sheet while rotating with the fixing member; and
a slide-contacting member in contact with the fixing member and configured to slide-contact with a surface of the fixing member by urging a slide-contacting surface comprising fiber material with respect to the surface of the fixing member when the sheet on which the toner image containing a photoluminescent pigment is formed, passes through the nip section.

6. A method for cleaning, comprising:
providing a sheet, on which a toner image is formed, to a rotatable fixing member;
heating the sheet with the fixing member;
press-contacting a rotatable pressing member to the fixing member to form a nip section, the pressing member configured to nip and transport the sheet while rotating with the fixing member;
contacting a slide-contacting member with the fixing member,
wherein the slide-contacting member slide-contact cleans a surface of the fixing member when the sheet on which the toner image containing a photoluminescent pigment is formed, passes through the nip section.

7. The method according to claim 6, further comprising controlling the slide-contacting member and the fixing member with a controller such that the slide-contact cleaning is performed a predetermined number of times until a second sheet on which a toner image containing a photoluminescent pigment is formed, passes through the nip section.

8. The method according to claim 6, further comprising:
extending a belt-shaped slide-contacting surface of the slide-contacting member in a width direction of the surface of the fixing member; and
controlling the fixing member with a controller such that the fixing member rotates at least a predetermined number of times, with the slide-contacting surface urged toward the surface of the fixing member.

9. The method according to claim 6, wherein the slide-contacting member comprises: a sheet-shaped slide-contacting member, a pair of supporting members disposed along a width direction of the surface of the fixing member, and an urging member disposed along the width direction of the surface of the fixing member, the method further comprising:
supporting front and rear ends of the sheet-shaped slide-contacting member with the pair of supporting members; and
urging a central portion of the sheet-shaped slide-contacting member toward the surface of the fixing member with the urging member.
